(19) United States
(12) Patent Application Publication
(10) Pub. No.: US 2014/0028614 A1
(43) Pub. Date: Jan. 30, 2014

(54) PORTABLE TERMINAL HAVING INPUT UNIT AND METHOD OF DRIVING THE INPUT UNIT

(71) Applicant: Samsung Electronics Co., Ltd, Gyeonggi-do (KR)

(72) Inventors: Yu-Dong BAE, Gyeonggi-do (KR); Eun-Hwa LEE, Gyeonggi-do (KR); Jeong-Seok LEE, Gyeonggi-do (KR)

(73) Assignee: Samsung Electronics Co., Ltd.

(21) Appl. No.: 13/943,338

(22) Filed: Jul. 16, 2013

(30) Foreign Application Priority Data
Jul. 30, 2012 (KR) 10-2012-0083402

(51) Int. Cl. G06F 3/044

(52) U.S. Cl. CPC G06F 3/044
USPC 345/174

(57) ABSTRACT

Disclosed is a portable terminal including an input unit, which includes a first sensor configured to input a signal to the portable terminal, a second sensor configured to sense an activation signal of the input unit, and an actuator configured to drive the input unit when the activation signal is sensed.

### PRIORITY

This application claims priority under 35 U.S.C. §119(a) to a Korean Patent Application filed in the Korean Intellectual Property Office on Jul. 30, 2012 and assigned Serial No. 10-2012-0083402, the contents of which are incorporated herein by reference.

### BACKGROUND OF THE INVENTION

1. Field of the Invention

The present invention relates generally to a portable terminal, and more particularly, to a portable terminal including an input unit, of which a surface is coplanar with a surface of the portable terminal and is configured to provide various types of haptic feedback depending on whether the portable terminal is activated, and a method of driving the input unit.

2. Description of the Related Art

Buttons for inputting information to an electronic device are currently designed in various shapes depending on the use thereof, but employ a mechanical button unit for providing a touch feeling, and a button icon for expressing a meaning of a button visually as a basic configuration. The buttons include buttons attached to a computer keyboard, operating buttons of various portable appliances (for example, a phone book, a portable terminal, an electronic diary, and a game machine), buttons attached to a remote controller or buttons on various common electronic products.

Although buttons currently vary in shape and size, the buttons are generally for a device for providing visual information, and a device for providing haptic information. An example of the button provided with the device for providing the haptic information is implemented through a spring, and an example of the button provided with the visual information has a top that is provided with an icon expressed in such a manner that a user can recognize the meaning of the button. In other words, the prior art teaches that portable terminal buttons be configured in a form that provides not only visual information but also haptic information to a portable terminal user. For example, the prior art teaches that inputting is executed either using dome keys or using electrostatic soft keys to operate icons without operating physical keys. In addition, U.S. Patent Application Publication No. US 2011/0107958 discloses a method of generating a haptic feedback using an air pump in order to implement various key button feelings, and U.S. Patent Application Publication No. US 2008/0010593 discloses a method of transmitting a physical key feeling as a key itself is represented as a pop-up by an action of a motor.

Recent portable terminals are operated by touch-inputting through a screen, in particular through a full screen touch (hereinafter full touch) in which when a button of the portable terminal is operated to conduct inputting to the portable terminal, an inputting error may occur according to the full touch of the screen, causing a user inconvenience. In other words, when a portable terminal is operated through a full touch button-input, the portable terminal provides a user with visual and haptic information in accordance with the button-input through the screen. However, a button-inputting error may occur, and the full touch button-input is inconvenient.

Accordingly, there is a need in the art for a method of conducting the button-inputting of the portable terminal easily and flawlessly, and for providing visual and haptic information to the user according to the button-inputting of the portable terminal.

### SUMMARY OF THE INVENTION

Accordingly, an aspect of the present invention is to provide a portable terminal having an input unit that can implement an aesthetic sense and elegance and can prevent unintended driving of the portable terminal due to an external environment or erroneous manipulation, and a method of operating the input unit. Another aspect is to provide a portable terminal having an input unit capable of providing various types of haptic feedback to a user, and a method of driving the input unit.

According to an aspect of the present invention, there is provided a portable terminal having an input unit, which includes a first sensor configured to input a signal to the portable terminal, a second sensor configured to sense an activation signal of the input unit, and an actuator configured to drive the input unit when the activation signal is sensed.

According to an aspect of the present invention, there is provided a method of driving an input unit of a portable terminal, including sensing an activation signal of the input unit according to proximity or touch in relation to a second sensor of the input unit, driving the input unit by an actuator provided in the input unit when the activation signal is sensed, and sensing a signal-inputting by a first sensor provided in the input unit when the input unit is pushed or touched while the input unit is being driven.

### BRIEF DESCRIPTION OF THE DRAWINGS

The above and other aspects, features, and advantages of the present invention will be more apparent from the following detailed description taken in conjunction with the accompanying drawings, in which:

FIG. 1 illustrates a structure of a portable terminal provided with an input unit according to an embodiment of the present invention;

FIGS. 2 and 3 illustrate a structure of an input unit and a state of an actuator in a portable terminal having the input unit according to an embodiment of the present invention;

FIGS. 4 and 5 illustrate an input unit and an actuator in a portable terminal having the input unit according to an embodiment of the present invention when the input unit is in an inactivated condition and voltage is applied to the actuator;

FIGS. 6 and 7 illustrate an actuator in an activated condition and in an inactivated condition in a portable terminal having an input unit according to another embodiment of the present invention, respectively;

FIG. 8 illustrates a portable terminal provided with an input unit according to an embodiment of the present invention; and

FIG. 9 illustrates a method of driving an input unit of a portable terminal according to an embodiment of the present invention.

### DETAILED DESCRIPTION OF EMBODIMENTS OF THE INVENTION

Embodiments of the present invention will be described with reference to the accompanying drawings. In the following description, the same elements will be designated by the same reference numerals although they are shown in different drawings. Herein, a detailed description of known functions and configurations incorporated herein will be omitted for the sake of clarity and conciseness.

Although ordinal numbers, such as first and second, are used in the present invention to differentiate the objects with the same name from each other, the order of the objects may be arbitrarily determined and a preceding description may be applied to a postfix element.

The input unit of the present invention is configured in such a manner that, in a portable terminal receiving input through a touch panel of a screen, inputting is implemented through a side surface or a rear surface of the portable terminal beyond the inputting through the touch panel of the portable terminal. In other words, the inventive input unit (for example, a “button”) may be provided on any surface beyond the touch panel for executing inputting. That is, a button-inputting may be conducted without an error using an input unit provided on a side surface or a rear surface, and various forms of visual and haptic information, i.e. button icons, button operating feelings and a button touch feeling may be provided to the user.

For the sake of convenience, the following description will be based on when an input unit is provided on a side surface to easily conduct a button-inputting without error. However, the present invention can be equally applied to situations such as when the input unit is provided on another surface.

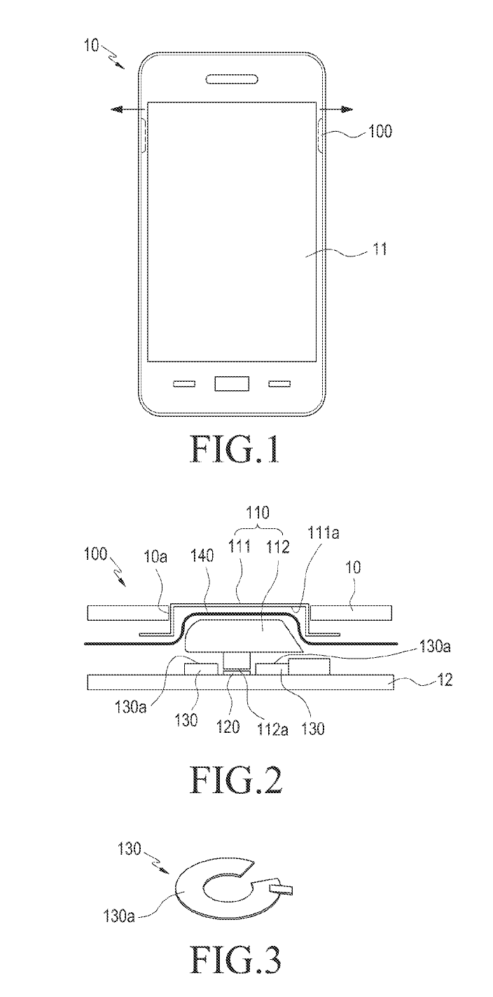

FIG. 1 illustrates a structure of a portable terminal provided with an input unit according to an embodiment of the present invention. Referring to FIG. 1, the portable terminal 10 is configured to receive button-input through a touch panel (hereinafter a screen), which is provided on the front surface of the terminal 10, to execute a first inputting, in which the screen 11 is displayed with button icons for such a button-inputting. That is, the portable terminal 10 provides button icons as visual information to the user through the screen 11. Along each side surface of the portable terminal 10, an input unit 100 is provided for inputting, such as controlling a volume key, turning power ON/OFF, or executing multimedia, which is different from the first inputting through the screen 11 (hereinafter a second inputting).

The input unit 100 should be firstly activated in order to execute the second inputting through the input unit 100, and an input signal of a contact pressure, such as pushing, should be secondarily input to the input unit 100. In this regard, the input unit 100 forms a surface that is coplanar with a surface of the portable terminal 10, and is provided as depressed into the portable terminal 10 with reference to the surface of the portable terminal 10. When the surface of the input unit 100 is provided to be coplanar with the surface of the portable terminal 10, the input unit 100 is in the inactivated condition that does not allow inputting. When a touch or proximity occurs in relation to the inactivated input unit 100, the input unit 100 is turned ON for allowing the second inputting, i.e. allowing a signal to be input through the input unit 100, but not allowing the second inputting.

FIGS. 2 and 3 illustrate a structure of an input unit and a state of an actuator in a portable terminal having the input unit according to an embodiment of the present invention. Referring to FIGS. 2 and 3, the input unit 100 provided on a side surface of the portable terminal 10 includes a button member 110 (hereinafter, a button 111 and a button driver 112 may be generally referred to as the button member), a first sensor 120, a second sensor 140, and an actuator 130. The second sensor 140, which is capable of sensing proximity or touch in relation to the button 111, is disposed on the surface of the input unit 100, in particular between the button 111 and the button driver 112. On the bottom side of the input unit 100, in particular under the button driver 112, an actuator 130 is installed to provide a haptic feedback to the button 111 and the button driver 112, or to cause the button 111 and the button driver 112 to protrude from the side surface of the portable terminal 10.

The button member 110 includes the button 111 and the button driver 112. The button 111 provides a surface that is coplanar with that of the portable terminal 10, and is configured to allow the user to visually or haptically confirm the position of the input unit 100. If the input unit 100 is configured to provide only a haptic feedback on the surface of the portable terminal 10, the button 111 may be formed integrally with the surface of the portable terminal 10. In such a case, the button 111 may further include a configuration that is differentiated from the surface of the portable terminal 10, and allows the user to recognize the position of the button 111. For example, protuberances, such as embossing, may be formed on the button 111 to allow the user to visually and haptically recognize the position of the button 111. In addition, the button 111 and the surface of the portable terminal 10 may have different colors or may be formed from different materials, so that the position of the button 111 can be visually confirmed.

When input unit 100 is configured to protrude or to be depressed with reference to the surface of the portable terminal 10, the button 111 may be depressed into an opening 10a in the portable terminal 10 to form the surface of the surface of the opening 10a, and may protrude from the surface of the portable terminal 10 as the button driver 112 (to be described later herein) is moved vertically by the actuator 130. The button driver 112 is configured to be disposed between the bottom 111a of the button 111 and the top 130a of the actuator 130 (to be described later herein), and to be driven by the actuator 130. In addition, the bottom surface 112a of the button driver 112 is configured to react with the first sensor 120 to sense the application of an input signal from the activated input unit 100.

The actuator 130 is configured to lift the button driver 112 or to provide a haptic feedback in response to sensing the activation signal of the input unit 100 or an input signal. As the actuator 130 is driven, the button driver 112 and the button 111 are lifted from the surface of the portable terminal 10, or the haptic feedback produced from the actuator 130 is transmitted to the button 111 through the button driver 112.

The button 111 provided on the top side of the button driver 112 is pushed by the button driver 112 to protrude from the surface of the portable terminal 10. The button 111 and the button driver 112 are configured to be lifted by the actuator 130 and to protrude from the surface of the portable terminal 10 by way of an example. However, the button 111 and the button driver 112 are not limited to this configuration. For example, if the button 111 forms a surface that is coplanar with the surface of the portable terminal 10, and the button driver 112 is configured to transmit the vibration produced in the actuator 130, the activated input unit 100 may still be configured in such a manner that the user can be provided with a haptic feedback produced by the actuator due to a contact pressure applied to the input unit 100, which provides a surface coplanar with the surface of the portable terminal 10 and is activated, and inputting can be executed.

The first sensor 120 and the second sensor 140 are configured to sense an input signal and an activation signal of the input unit 100, respectively. That is, the first sensor 120 is provided below the button driver 112 to react with the activated input unit 100, specifically with a touch with or the occurrence of a contact pressure on the bottom surface of the button driver 112 by a contact pressure applied to the button 111 in the activated condition, thereby sensing an application of an input signal. The second sensor 140 is configured to sense proximity or contact in relation to the input unit 100, thereby sensing the activation signal of the input unit 100, and is provided between the button 111 and the button driver 112 below the button 111.

In particular, the second sensor 140 is configured to sense whether the activation signal is applied by sensing the proximity or contact in relation to the button 111. The term, “activation” is used to indicate when the input unit 100 is turned ON for the second inputting. That is, when an object, such as a user's finger, approaches or touches the input unit 100 for the second inputting to the portable terminal 10 through the input unit 100, the second sensor 140 disposed adjacent to the surface of the input unit 100 recognizes this, and the actuator 130 is driven according to the sensing result of the second sensor 140. The input unit 100 is then completely prepared for the second inputting.

The second sensor 140 senses when proximity or contact in relation to the input unit 100 occurs. That is, the second sensor 140 senses that the activation signal is applied to the input unit 100, and the value sensed by the second sensor 140 is transmitted to the controller 150, so that the input unit 100 is controlled to be in the activated condition. No input signal is executed unless a further signal is sensed in the activated input unit 100 in this condition. When a contact pressure is applied to the input unit 100, for example when the activated input unit 100 is pushed or touched, the second sensor 140 senses that an input signal is produced in the activated input unit 100, and a sensed value controls the controller 150 in such a manner that an inputting is executed according to the input signal of the input unit 100. The second sensor 140 is configured by a touch sensor or a proximity sensor to sense proximity or touch for activating the input unit 100.

When the activation signal is sensed by the second sensor 140, the sensed value is applied to the controller 150 (see FIG. 8), and the controller 150 controls the input unit 100 to be turned ON, i.e. to be in the activated condition for the second inputting. The controller 150 controls the driving of the actuator 130 in such a manner that the button 111 and the button driver 112 are caused to protrude by the actuator 130. In addition, the actuator 130 may be operated to cause the input unit 100 to protrude to indicate the activated condition, or to cause a haptic feedback, such as various patterns of vibration or sound to be provided to the input unit 100.

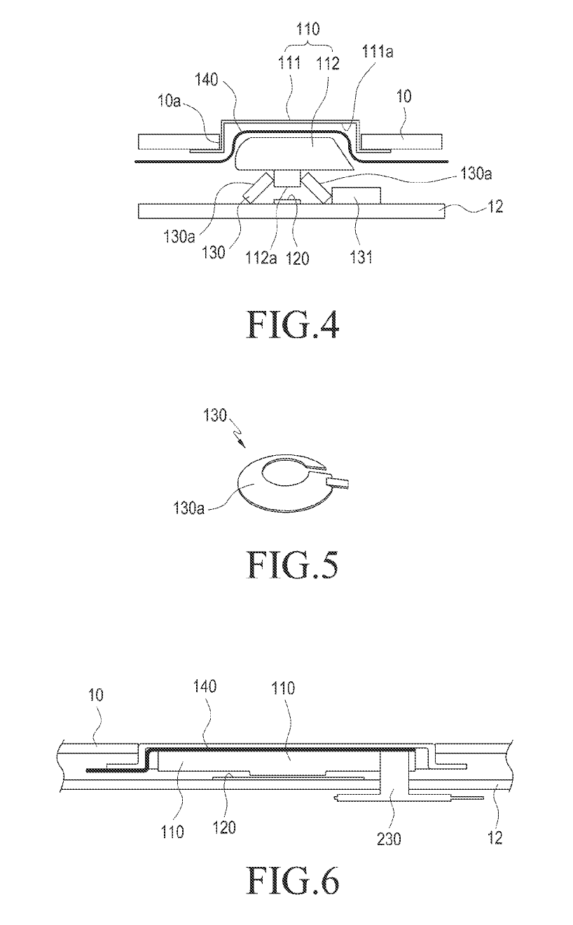

FIGS. 4 and 5 illustrate an input unit and an actuator in a portable terminal having the input unit according to an embodiment of the present invention when the input unit is in an inactivated condition and voltage is applied to the actuator. Referring to FIGS. 4 and 5, the actuator 130 is configured to inform the user that the input unit 100 is in a state in which the second inputting can be conducted, and when a contact pressure is applied to the input unit 100, to provide a haptic feedback to the user. Accordingly, when an activation signal is sensed by the second sensor 140, the actuator 130 may provide a haptic feedback, for example, vibration or sounds visually and haptically, or produce a physical deformation.

For example, the actuator 130 outputs an operating feeling or a touch feeling corresponding to the second inputting or the protrusion or depression of the input unit 100 as haptic information through vibration. The actuator 130 causes the input unit 100, which is in the depressed condition with reference to the surface of the portable terminal 10, to protrude to the outside of the surface of the portable terminal 10. The input unit 100 caused to protrude is in the activated condition, and if the user applies a contact pressure by pushing the input unit 100 when the input unit 100 is caused to protrude from the surface of portable terminal 10, the second inputting is conducted to the portable terminal 10. Although it is described that the actuator 130 or 230 is an EAP (Electro-Active Polymer) actuator 130 or a piezo-actuator 230 by way of an example (see FIGS. 2 to 7), the present invention is not limited to this actuator type. If the actuator 130 or 230 is configured to be capable of activating the input unit 100 for the user's second inputting, or to be capable of providing an operating feeling or a touch feeling of the input unit 100, the actuator 130 or 230 may be changed or modified in any operable manner.

FIGS. 2 to 5 describe when an EAP actuator is provided as the actuator 130. The EAP actuator 130 is provided in a donut shape under the input unit 100, specifically around the bottom side of the button driver 112. One side of the EAP actuator 130 is connected to a board 131 that applies a voltage to the EAP actuator 130, and the board 131 is connected to a main circuit board 12. When a voltage is applied to the EAP actuator 130, the EAP actuator 130 is expanded or contracted and activates the input unit 100 to be in a state in which the second inputting is enabled. If the expansion and contraction of the EAP actuator 130 are repeated, a haptic feedback, such as vibration, is applied to the input unit 100. If the expanded condition is maintained, the EAP actuator 130 lifts the input unit 100 to be maintained in the protrusion condition.

If the inputting situation for the input unit 100 is removed, the voltage applied to the EAP actuator 130 is released. Accordingly, the EAP actuator 130 is returned to its original condition. That is, if the contraction and expansion of the EAP actuator 130 are adapted to be repeated to provide the haptic feedback, the haptic feedback will be stopped, and if the EAP actuator is adapted to be expanded to cause the input unit 100 to protrude, the EAP actuator 130 will be contracted to cause the input unit 100 to be depressed into the inside of the portable terminal 10 to form a surface that is coplanar with the surface of the portable terminal 10. As a result, the input unit 100 is inactivated.

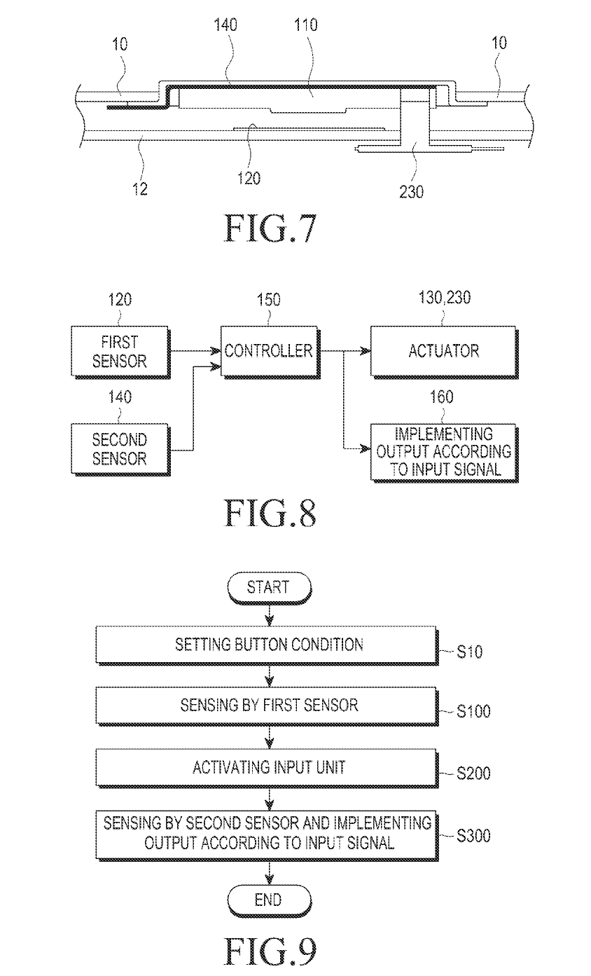

FIGS. 6 and 7 illustrate an actuator in an activated condition and in an inactivated condition in a portable terminal having an input unit according to another embodiment of the present invention, respectively. FIGS. 6 and 7 describe when a piezo-actuator is employed as the actuator 230. The piezo-actuator 230 is disposed on the bottom side of the input unit 100 in such a manner that when no voltage is applied thereto, the input unit 100 is maintained to be coplanar with the surface of the portable terminal 10 surrounding the input unit 100.

When the second sensor 140 senses a proximity or contact in relation to the input unit 100, a sensed value is recognized by the controller 150, and the controller 150 controls the piezo-actuator 230 to be driven. As the piezo-actuator 230 is driven, the piezo-actuator activates the input unit 100 for button inputting, and pushes the input unit 100 upward to protrude to the outside of the surface of the portable terminal 10. In addition, the proximity or contact in relation to the input unit 100 is removed, and the piezo-actuator 230 returns to its original condition, thereby causing the input unit 100 to return to its original position. Accordingly, the input unit 100 is moved to provide a surface that is coplanar with the surface of the portable terminal 10, and input unit 100 is returned to the inactivated condition.

A first sensor 140 is further provided on a printed circuit board 131 below the input unit 100, as shown in FIG. 4,and is configured to sense a second inputting when the input unit 100 is touched or a contact pressure is applied to the input unit 100 (see FIGS. 2, 4, 6 and 7). That is, when the input unit 100 is activated and a contact pressure is applied to the input unit 100, the bottom surface of the input unit 100, in particular the bottom surface 112a of the button driver 112 is contacted with the first sensor 120, and the first sensor 140 senses the variation of the contact pressure applied to the button 111 and the button driver 112, thereby transmitting a signal for the second inputting. The first sensor 140 includes a resistance sensor.

Accordingly, the button driver 112 is normally depressed into the side surface of the portable terminal 10, and the button 111 forms a surface that is coplanar with the inner surface of the portable terminal 10. In this state, when a touch or proximity is made in relation to the button 111, the second sensor 140 senses that an activation signal is provided to the input unit 100. When the activation is sensed by the second sensor 140, a sensed value is applied to the controller 150. The controller 150 controls the actuator 130 or 230 to be driven, thereby producing a haptic feedback or a physical deformation, such as protrusion, and activating the input unit 100. As a result, the user can recognize that the input unit 100 is activated to when the second inputting can be conducted.

When a user's finger is contacted with the activated input unit 100 or a contact pressure is applied to and pushes the activated input unit 100, the first sensor 140 disposed in the bottom side of the input unit 100 senses an input signal input in this regard, during which time the controller 150 controls the portable terminal 10 to be operated according to the input signal. That is, as the second inputting is conducted through the contact pressure in relation to the activated input unit 100, the portable terminal 10 is enabled to execute various functions.

For example, when a user's finger (or the like) approaches or touches the input unit 100 when a camera photographing mode is activated, the input unit 100 is caused to protrude from the surface of the portable terminal 10 or produces a vibration thereon while forming its surface to be coplanar with the surface surrounding the input unit 100, so that the user can recognize that the input unit 100 is activated. If the user applies a contact pressure to the input unit 100, the input unit 100 reacts with the first sensor 140 disposed below the input unit 100 to allow photographing to be conducted.

Accordingly, when a contact or proximity in relation to the input unit 100 occurs, the input unit 100 is maintained in the activated condition rather than directly executing a function according to the second inputting. As a result, the second inputting is prevented from being erroneously executed by an erroneous touch or erroneous proximity in relation to the input unit 100. In addition, because a haptic feedback or a physical deformation is produced in the input unit 100, the user is visually and haptically informed that the second inputting can be conducted.

FIG. 8 illustrates a portable terminal provided with an input unit according to an embodiment of the present invention, and FIG. 9 illustrates a method of driving an input unit of a portable terminal according to an embodiment of the present invention.

Referring to FIGS. 8 and 9, button information for the button icons used for a button-inputting by touching the screen 11 of the portable terminal 10 and button information for the input unit 100 implemented on a side surface of the portable terminal 10 are set in step S10. The user touches the button 111 with a finger or positions the finger proximately to the button 111 in order to execute an inputting through the input unit 100 provided on a side surface of the portable terminal 10. The second sensor 140 provided below the button 111 senses an activation signal produced by the touch or proximity in step S 100. When the activation signal is sensed by the second sensor 140, a sensed value is applied to the controller 150, and the controller 150 controls the actuator 130 or 230 to be driven according to the sensed value. A voltage is applied to the actuator 130 or 230 provided below the button driver 112, and the actuator 130 or 230 applies a force to the button driver 112 to the outside of the side surface of portable terminal 10, thereby causing the button 111 to protrude from the side surface of the portable terminal 10. The input unit 100 is in the activated condition in which an inputting is enabled in step S200.

When the button 111 and the button driver 112 do not protrude from the side surface of the portable terminal 10, that is, the button 111 forms a surface that is coplanar with the side surface of the portable terminal 10 even when the input unit 100 is activated, the actuator 130 or 230 may provide a haptic process, such as vibration, to the user so that the user can recognize that the input unit 100 is in the activated condition.

When the user pushes or touches the activated input unit 100, in particular the button 111 protruding from the side surface of the portable terminal 10 to apply a contact pressure, the first sensor 140 senses the contact pressure applied to the input unit 100, and then the second inputting may be executed in step S300. That is, the input signal value sensed by the first sensor 120 is applied to the controller 150, which in turn controls the actuator 130 or 230 and hence the execution of the portable terminal 10 according to the input signal. The actuator 130 or 230 provides vibration or sounds to provide the user with a haptic feedback, and the second inputting according to a button-inputting is executed in the portable terminal 10.

Specifically, if the input unit 100 is in the protrusion condition by the actuator 130 or 230, the input unit 100 is pushed by the user's contact pressure, and the bottom surface of the input unit 100 is caused to contact the first sensor 140. Due to this, for example, a multimedia function preset in the portable terminal 10 is executed according to the second inputting by the input unit 100 based on the value sensed by the first sensor 140. In addition, if a haptic feedback is adapted to be provided by the actuator 130 or 230 when the input unit 100 is depressed into the portable terminal 10, the first sensor 140 senses the contact pressure applied to the input unit 100, and a function by the second inputting is executed based on the value sensed by the first sensor 140. It is also possible for the actuator 130 or 230 to be driven to provide various types of haptic feedback, such as sounds or vibration.

In addition, when no button-inputting, such as a touch or proximity in relation to the input unit 100, is executed within a period of time, the activated input unit 100 becomes inactivated. That is, the voltage applied to the actuator 130 or 230 is released, and then the input unit 100 protruding from the surface of the portable terminal 10 by the actuator 130 or 230 returns to its original position. Specifically, when the input unit is configured to protrude from the surface of the portable terminal 10, the input unit 100 is depressed to form a surface that is coplanar with the surface of the portable terminal 10 surrounding the input unit 100. In addition, when the input unit 100 forms a surface that is coplanar with the surface of the portable terminal 10 and provides a haptic feedback, the voltage applied to the actuator 130 or 230 is released so that the input unit 100 becomes inactivated.

Accordingly, because the input unit in the embodiments described above forms a surface that is coplanar with the surface of the portable terminal, the input unit allows the portable terminal to be elegantly designed and prevents malfunction of the portable terminal. In addition, the input unit can provide various types of haptic feedback when being activated.

In accordance with the present invention, because an input unit for conducting an inputting different from an inputting conducted through a touch panel of a screen is provided to form a surface that is coplanar with a side surface of a portable terminal, in particular to the surface of the portable terminal surrounding the input unit, the input unit is prevented from being erroneously operated by being erroneously pushed according to an external environment. In addition, because the activation of the input unit is determined according to a proximity or touch in relation to the input unit, and an input signal is provided when the input unit is activated and then pushed or touched, the input signal is not directly produced only by touching or pressing the input unit, whereby it is possible to prevent malfunction of the input unit.

In addition, when the input unit is activated, the actuator protrudes with reference to the surface of the portable terminal or provide a haptic feedback, whereby the activation of the input unit is recognized by the user and various types of haptic feedback are provided to the user.

Furthermore, because the input unit may be disposed inside a side surface of the portable terminal or another surface of the portable terminal, for example rear surface (not shown), (although the input unit is not disposed on the side surface of the portable terminal, it can be disposed on another surface of the terminal which is attaching the touch panel, e.g., the rear surface) and the input unit may implement a surface that is coplanar with the surface of the portable terminal prior to using the button in the input unit, damage by an external force to the input unit is prevented, and design the portable terminal is made attractive.

While the present invention has been shown and described with reference to certain embodiments thereof, it will be understood by those skilled in the art that various changes in form and details may be made therein without departing from the spirit and scope of the present invention as defined by the appended claims.

What is claimed is:

1. A portable terminal including an input unit, the input unit comprising:
a first sensor configured to input a signal to the portable terminal;
a second sensor configured to sense an activation signal of the input unit; and
an actuator configured to drive the input unit when the activation signal is sensed.

2. The portable terminal of claim 1, wherein the first sensor is configured to execute inputting of a signal when the input unit in an activated condition is touched or pushed.

3. The portable terminal of claim 2, wherein the first sensor includes a touch sensor or a variable resistance type sensor.

4. The portable terminal of claim 3, wherein the touch sensor includes a capacitive type touch sensor or a resistive type touch sensor.

5. The portable terminal of claim 1, wherein the second sensor is provided on a surface of the input unit, and is configured to activate the input unit by sensing the activation signal by proximity or touch in relation to the input unit.

6. The portable terminal of claim 5, wherein the actuator is configured to cause the input unit to protrude outside of or to be depressed into the portable terminal, depending on whether the input unit is activated.

7. The portable terminal of claim 6, wherein the actuator outputs an operating feeling and a touch feeling corresponding to a signal-inputting of the first sensor and the protrusion or depression of the input unit.

8. The portable terminal of claim 7, wherein the actuator comprises an EAP (Electro-Active Polymer) actuator that expands or contracts, depending on whether a voltage is applied.

9. The portable terminal of claim 8, wherein the EAP actuator is configured to be expanded when a voltage is applied thereto, thereby causing the input unit to protrude outside of portable terminal, and to be contracted when the applied voltage is released, thereby causing the input unit to be depressed into portable terminal.

10. The portable terminal of claim 7, wherein the actuator comprises a piezo-actuator configured to vertically move the input unit depending on whether a voltage is applied thereto.

11. The portable terminal of claim 9, wherein the piezo-actuator is configured in such a manner that, when the voltage is applied to the piezo-actuator, the piezo-actuator moves the input unit upward, thereby causing the input unit to protrude outside of the portable terminal, and when the voltage is released from the piezo-actuator, the piezo-actuator moves the input unit downward, thereby causing the input unit to be depressed into the portable terminal when the applied voltage is released.

12. The portable terminal of claim 6, wherein the input unit further comprises:
a button forming a surface that is coplanar with the surface of the portable terminal; and
a button driver disposed between a bottom of the button and a top of the actuator, and configured to be lifted by the actuator.

13. The portable terminal of claim 12, wherein the second sensor is provided between the button and the button driver.

14. The portable terminal of claim 3, wherein when information or an icon displayed on the portable terminal screen is moved by touch or a motion, the controller causes the actuator to provide a haptic feedback by the activated input unit, or causes the actuator to protrude the activated input unit from a side surface of the portable terminal.

15. A method of driving an input unit of a portable terminal, comprising:
sensing an activation signal of the input unit according to proximity or touch in relation to a second sensor of the input unit;
driving the input unit by an actuator provided in the input unit when the activation signal is sensed; and
sensing a signal-inputting by a first sensor provided in the input unit when the input unit is pushed or touched while the input unit is being driven.

16. The method of claim 15, further comprising:
controlling, by a controller, the signal-inputting provided to the input unit by pushing or touch sensed by the first sensor, or controlling the activation signal of the input unit on the basis of proximity or touch sensed by the second sensor.

17. The method of claim 16, wherein the actuator comprises an Electro-Active Polymer (EAP) actuator provided under the input unit, which causes the input unit to protrude or to be depressed with reference to the surface of the portable terminal, and
the controller controls the EAP actuator to be expanded or contracted depending on a detected value so that the input unit is caused to protrude outside of or to be depressed into the portable terminal.

18. The method of claim 16, wherein the actuator comprises an Electro-Active Polymer (EAP) actuator provided under the input unit, which causes the input unit to protrude or to be depressed with reference to the surface of the portable terminal, and
the controller vertically moves the input unit depending on the sensing result of the second sensor through the piezo-actuator so that the input unit protrudes outside of or is depressed into the portable terminal.
